(19) United States
(12) Patent Application Publication
(10) Pub. No.: US 2011/0264729 A1
(43) Pub. Date: Oct. 27, 2011

(54) AUGMENTATION OF NETWORK TRAFFIC

(76) Inventor: Denis Kulgavin, San Francisco, CA (US)

(21) Appl. No.: 13/090,579

(22) Filed: Apr. 20, 2011

Related U.S. Application Data
(60) Provisional application No. 61/328,571, filed on Apr. 27, 2010.

(51) Int. Cl. G06F 15/16

(52) U.S. Cl. 709/203

(57) ABSTRACT

Access to services hosted by a given server (150) is provided to clients (110) via any HTML document, at any URL, by intercepting the HTML documents transmitted to the client and augmenting the documents with a reference to the server's code (178). The server's code (e.g. ActionScript action codes) is fetched and executed by the client's browser (140) or a suitable interpreter (182). State data (510) track the code's state during execution. If the client downloads new HTML documents, a new instance of the code 178 is re-loaded from the server and placed into the current state in accordance with the state data. Execution continuity is therefore provided for the code. Interfaces (e.g. for copying of objects from HTML documents to code 178) can be defined between HTML documents and the code via browser API (186) which may include, for example, DOM (direct object model). Other embodiments are also provided.

The present application claims priority of U.S. provisional patent application No. 61/328,571, filed by Denis Kulgavin on Apr. 27, 2010, entitled “AUGMENTATION OF NETWORK TRAFFIC”, incorporated herein by reference.

### BACKGROUND OF THE INVENTION

The present invention relates to computer networks.

Computer networks are widely used for delivery of information and of network-hosted services. FIG. 1 illustrates document delivery via Wide World Web (WWW) to a person (“user”) operating a computer 110 connected to the Internet 112. Computer 110 has hardware components 114 including a computer processor 120 and possibly other processors (not shown), and also including computer storage 124, a network interface card (not shown), and user interface devices 130. UI devices 130 may include a monitor with a screen 132 and may also include other devices (not shown) such as a keyboard, a mouse, speakers, and a microphone. The processor 120 and possibly other processors execute software 134 stored in storage 124. Software 134 includes a network browser 140. The user uses UI devices 130 to specify a uniform resource locator (URL) of a desired resource on the network. The browser uses the URL to obtain the network address of the resource, and sends a resource request 136 to the network address. Network routers (not shown) route the request to a server computer 150 hosting the resource. The resource can be an HTML document 160 for example. Server 150 sends document 160 to the client computer 110 over the Internet. Browser 140 creates, in storage 124, some representation 170 of document 160. Browser 140 uses the document representation 170 to render the document on UI 130, e.g. in a window 174 on screen 132 and/or on audio devices.

The data exchange may be bidirectional, i.e. the request 136 may be accompanied by other data entered by the user into a previously rendered representation of an HTML document 160. Server 150 processes the data and provides the results in a new document 160. Getting the new document from server 150 involves a delay however, but this delay can be avoided if the previous document 160 includes data processing code 178 which can process the user-entered data (the user input). Such code 178 is executed by the browser, or by a program 182 (e.g. an interpreter) invoked by the browser and executed by client 110. Code 178 causes the browser to generate the new document without contacting the server. The new document's representation 170 is rendered on screen 132.

Rather than containing the code 178, the previous document 160 may include a reference (URL) to code 178 hosted by another computer. The browser uses the URL to fetch code 178 over the network. This involves a network delay, but this delay can be smaller than if the user input is processed at the server.

Code 178 can be used to provide network-hosted services. For example, code 178 may include a word processor or other software embedded, directly or by reference, into an HTML document 160 provided by server 150. Code 178 is loaded into client 110 when the client fetches the HTML document. Such software 178 is easy to manage, i.e. to update and distribute to the users. Indeed, the update needs to be performed only on server 150, and the users get updated software whenever they reload the HTML document associated with the software.

It is desirable to facilitate network-hosted services.

### SUMMARY

This section summarizes some features of the invention, but is not intended as an exhaustive explanation of all the aspects of the invention. Other features are explained in subsequent sections. The invention is defined by the appended claims

In some embodiments of the present invention, providing network-hosted services is facilitated by inserting code 178 or references to code 178 into arbitrary HTML documents 160. The documents 160 as hosted in the Internet are not necessarily associated in any way with the code 178. Such insertion of code 178 or references to the code will be called “augmentation” herein. The augmentation can be performed, for example, by an entity intercepting the HTML documents on the way to the browsers.

In the example of FIG. 2, the augmentation is performed by augmenter 204 located in the network path between client 110 and the Internet 112. Augmenter 204 can be implemented, for example, as a separate computer (e.g. an “appliance” computer dedicated to the augmentation), or as a software entity executed by some computer, e.g. by client 110 or a router (not shown) connecting the client 110 to the Internet. In FIG. 2, the user requests HTML documents 160 from arbitrary servers 210 which may be related or unrelated to server 150 hosting the code 178. The HTML documents are augmented by augmenter 204 with an augment 220 referencing the code 178.

FIG. 3 illustrates an example in which the client 110 is connected to a network 310 (e.g. a LAN, i.e. local area network, or MAN, i.e. metropolitan area network) belonging to an organization such as a college or a hotel. The users may be patrons (hotel guests or students) or employees of the organization, and computers 110 may be the organization's computers or the users' own computers connected to network 310. Router 320 connects network 310 to the Internet, and augmenter 204 is connected between router 320 and the Internet. The operator of server 150 provides services to the entire network 310, possibly under an agreement with the organization. Such services do not require advance installation of software on client computers 110. The services become available at a client 110 whenever the client fetches any HTML document from any site on the Internet. (The computers 110 are called “clients” for ease of reference because they act as clients in interacting with servers 150, 210 as described above; computers 110 may also act as servers in other operations.)

Further, some embodiments provide continuity in execution of code 178 across multiple HTML documents 160. More particularly, when the browser fetches a new HTML document 160, the browser may discard the document representation 170 of the previous document 160 and also discard the browser's copy of the code 178 loaded and executed in connection with the previous document. However, in some embodiments, the current state of code 178 is maintained by server 150 and/or client computer 110 as state data 510 (FIG. 2). When the new augmented HTML document is fetched by the browser, augment 220 causes the browser to reload code 178. The state data 510 are then used to restore the state of code 178 as needed to provide continued execution of the code. In some embodiments, state data 510 define the contents of the overlays 190 and also define how the user input (and possibly other input) should be interpreted by code 178.

In some embodiments, if the user simultaneously runs browsers 140 in multiple windows 174, on the same or different clients 110, then the code 178 associated with different windows is in the same state as defined by the state data 510. This may mean, for example, that each window 174 is provided with an overlay 190 displaying the same content. The user can switch between the windows 174 to interact with different documents 160 or with different portions of the same document 160 displayed in different windows. The user may also interact with code 178 through different windows in continued execution of the code. (“Continued execution of the code” may actually mean continued execution of different instances of the code, but in some embodiments the different instances are manifested as a single instance to the user.)

Further, code 178 can interact with the HTML documents via the browser's application programming interface (“API”) 186. API 186 may be DOM-compliant for example. “DOM” (Document Object Model) is a specification for an interface to documents' features. DOM is defined by The World Wide Web Consortium (W3C) having an office in Cambridge, Mass., USA. DOM is described in [R5], [R6], [R7]. API 186 can be used for example as follows. Suppose that code 178 is a word processing program (WP) used to edit a word-processing document (WP document). The user may wish to copy text and images from arbitrary HTML documents 160 into the WP document, and it may be desirable to provide a convenient user interface for the copying operation. For example, in some embodiments, the user may simply double-click on an image in an arbitrary HTML document 160, and in response the image will be copied into the WP document. This double-click interface is provided via the API 186. More particularly, word processor 178 uses API 186 to inject some script (e.g. in JavaScript language described below) into the DOM representation 170 of the HTML document. The JavaScript will cause the browser to notify WP 178 of double-click events. These notifications will identify the image (the “target”) which was double-clicked by the user. WP 178 will then import the image into the WP document.

If the user loads a new HTML document, the state of word processor 178 is maintained as described above. The new instance of word processor 178 is loaded into the client, and uses API 186 to inject JavaScript to set up the double-click notifications for the new document, so the user can copy images from the new HTML document into the same WP document without issuing a command to re-load the WP.

Code 178 can be in a scripting language such as JavaScript or VBScript. JavaScript is described, for example, in [R1], i.e. in the reference R1 listed at the end of this disclosure before the claims. VBScript is described in [R2]. Code 178 can also be in Java bytecodes or action codes. (Action codes are compiled from ActionScript; Java is described in [R3], and ActionScript in [R4].) For example, program 182 may include a JavaScript interpreter, or a VBScript interpreter, or a Java Virtual Machine which executes Java bytecodes, or a Flash Player which executes action codes. (Flash Player is available from Adobe Systems Incorporated of California, USA.)

The invention is not limited to DOM, JavaScript or any other language, or other features described above except as defined by the appended claims. In particular, some embodiments of the invention do not require modification of document representations 170 and do not require event notification related to the documents. The Internet does not have to be used, other networks can be used instead. The augmenter 204 may be connected between the router 320 and LAN or MAN 310. Other embodiments and variations are within the scope of the invention as defined by the appended claims.

### BRIEF DESCRIPTION OF THE DRAWINGS

FIG. 1 is a block diagram illustrating network communication between computers according to prior art.

FIGS. 2 and 3 are block diagrams illustrating communication between computers according to some embodiments of the present invention.

FIGS. 4A-4C are a flow chart of a process performed in a computer network in some embodiments of the present invention.

FIG. 5A illustrates a computer network, a client computer's software, and a client computer's display at some stages of the process of FIGS. 4A-4C.

FIG. 5B illustrates a client computer's display at some stages of the process of FIGS. 4A-4C.

FIG. 5C illustrates a client's software and a client's computer display at some stages of the process of FIGS. 4A-4C.

FIG. 6 illustrates a server's data structures according to some embodiments of the present invention.

FIGS. 7 and 8 illustrate possible configurations of devices in a computer network in some embodiments of the present invention.

### DESCRIPTION OF SOME EMBODIMENTS

The embodiments described in this section illustrate but do not limit the invention. The invention is defined by the appended claims.

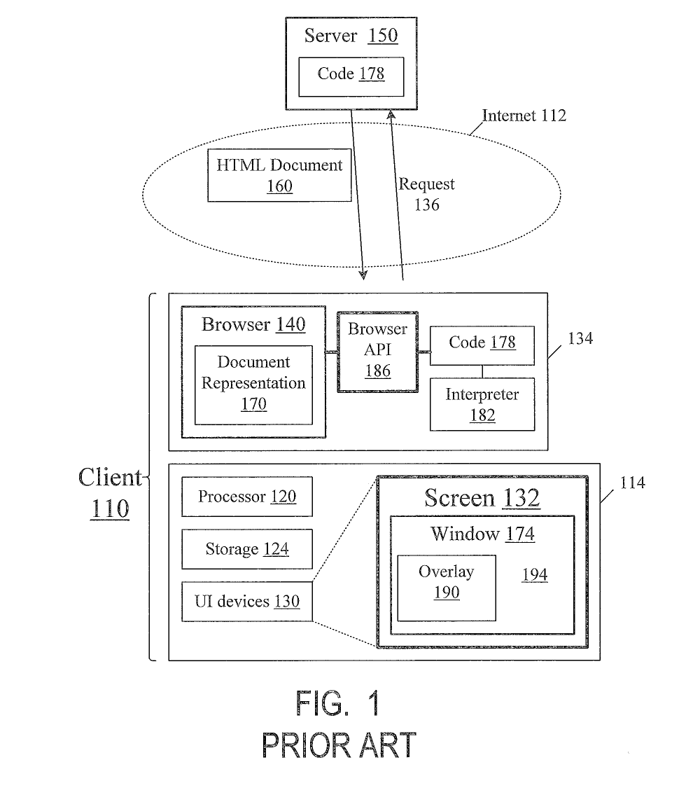

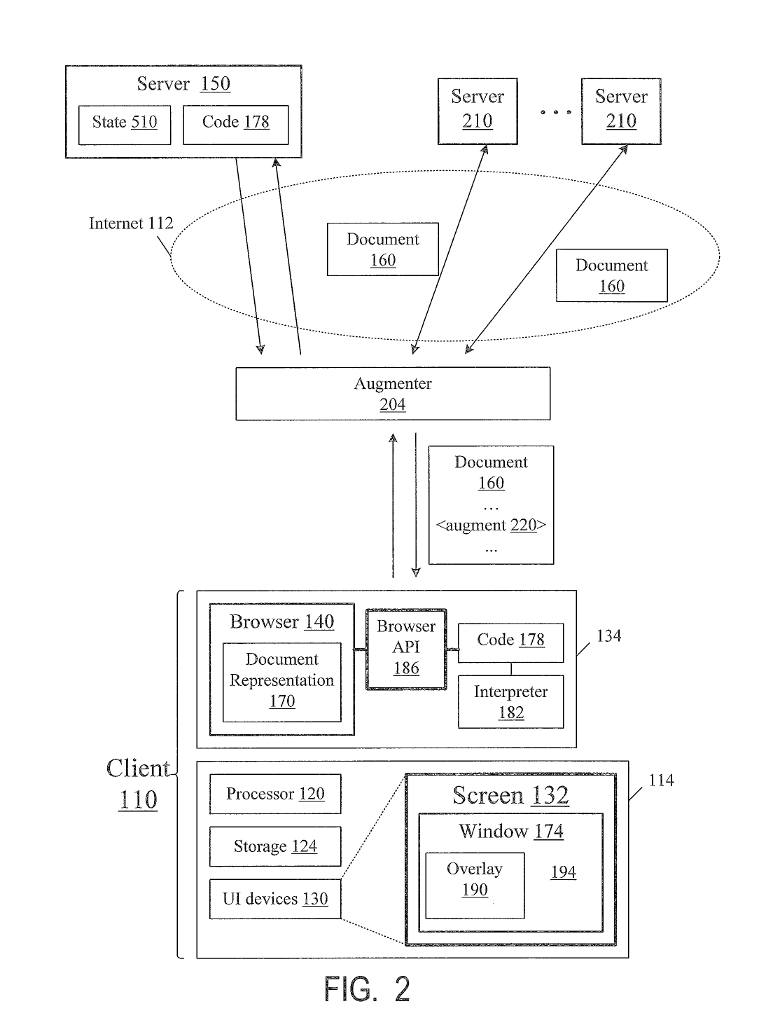

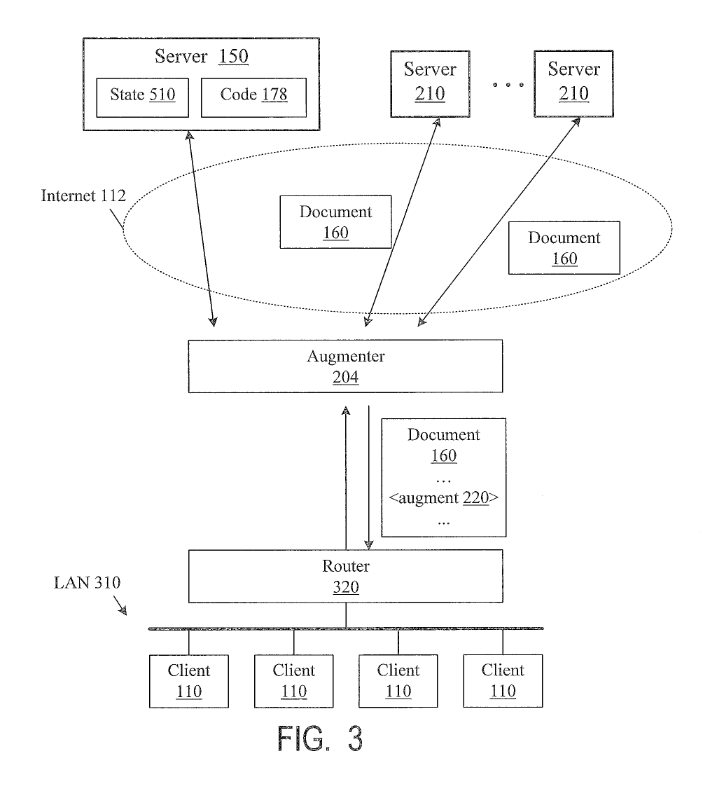

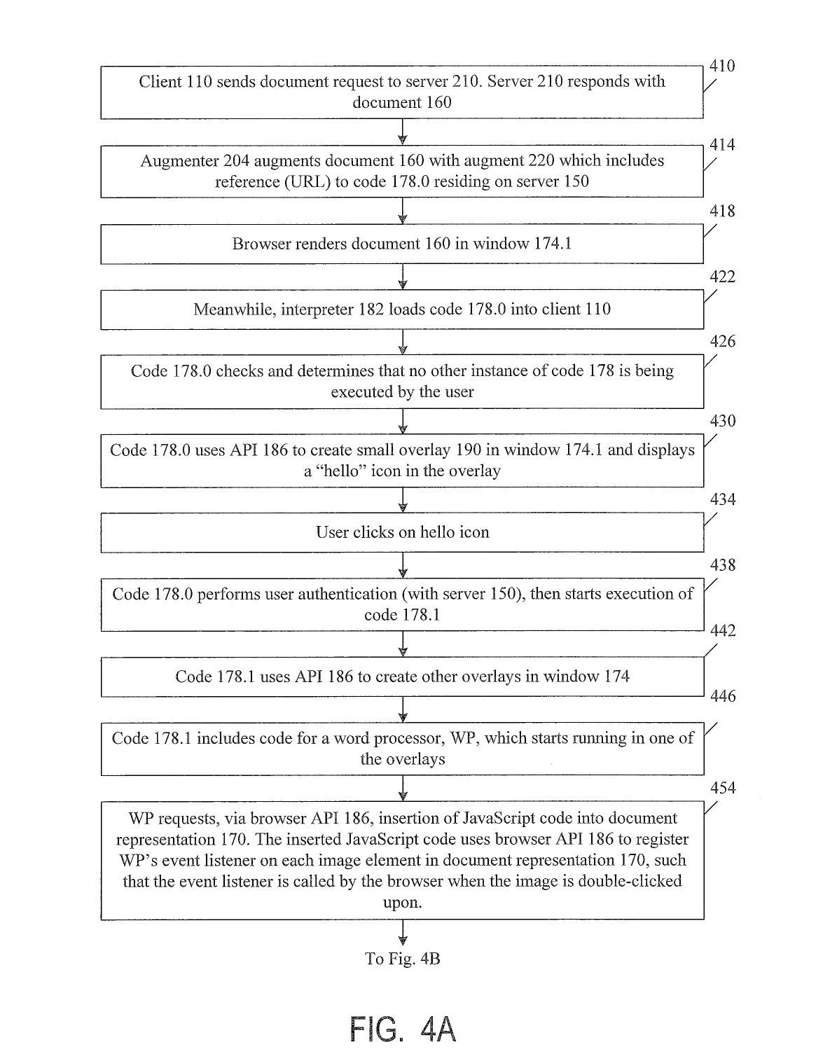

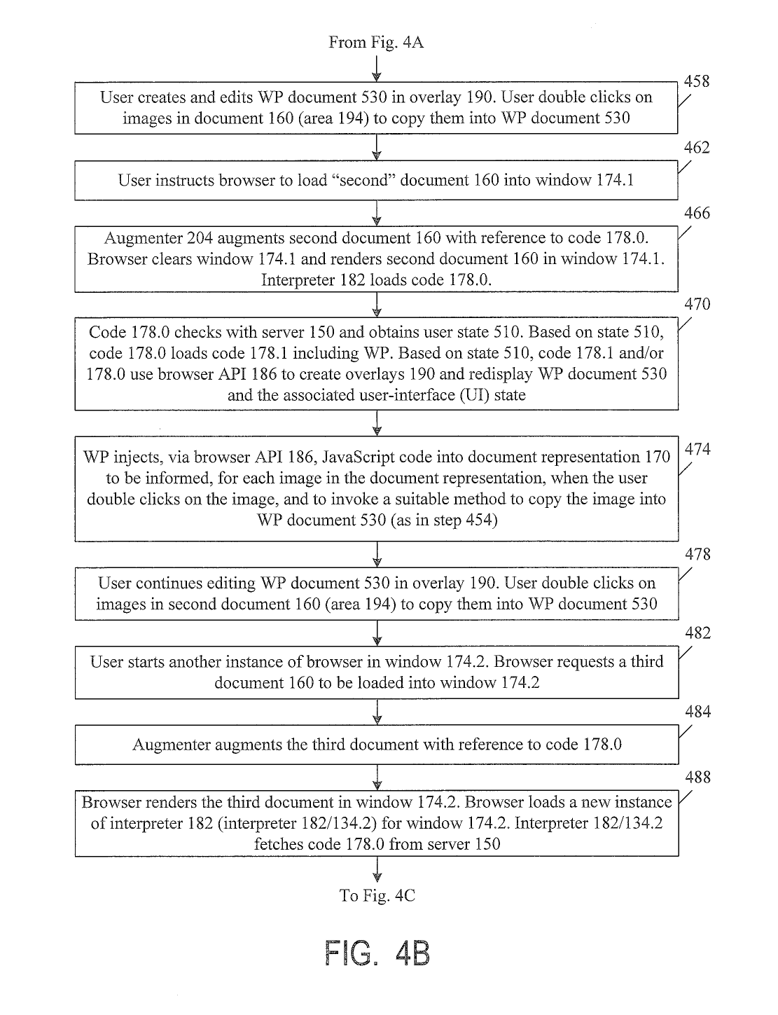

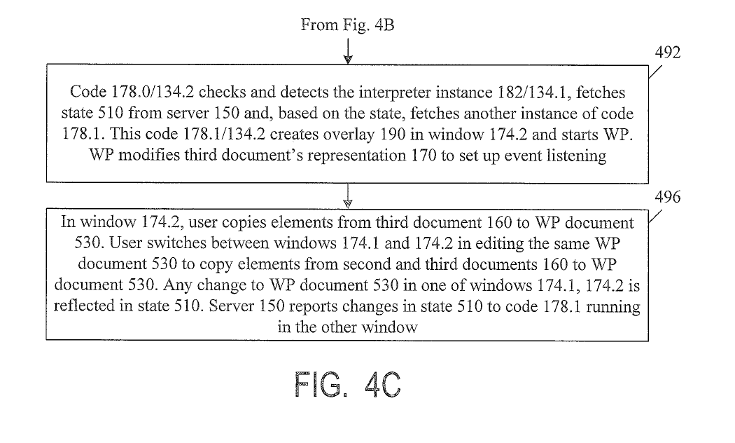

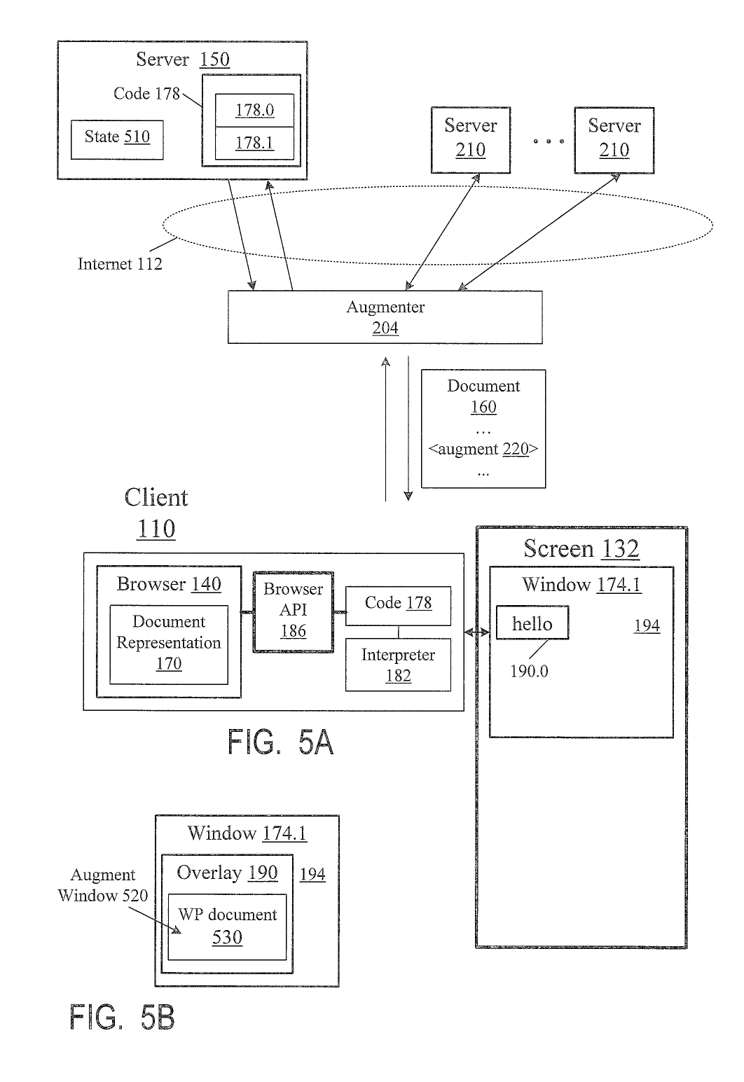

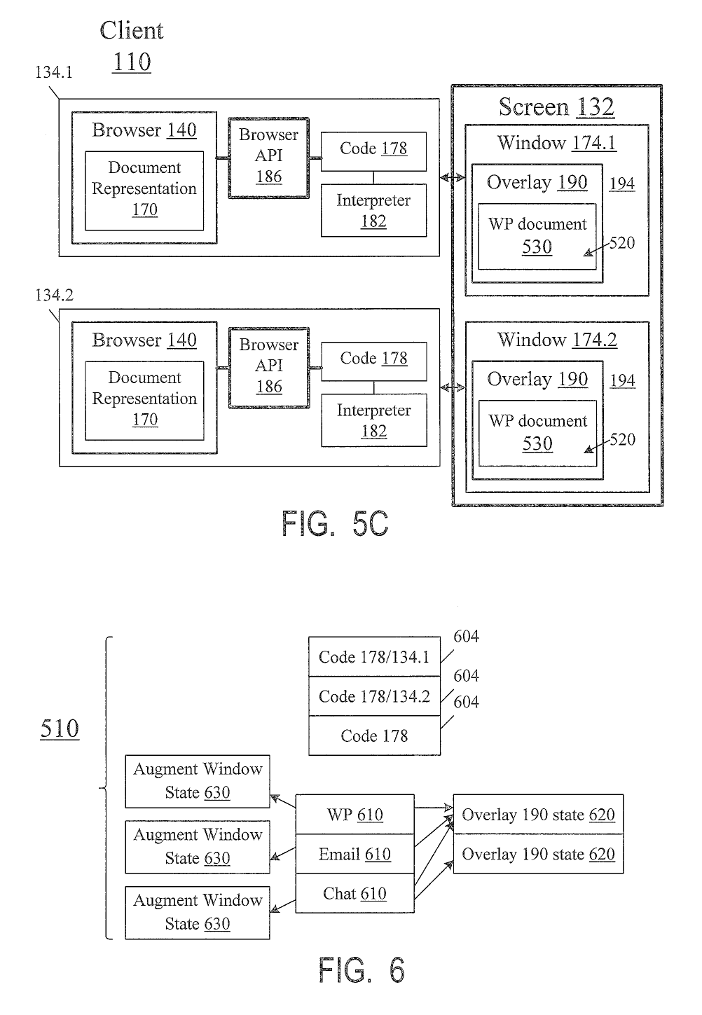

FIGS. 4A-4C illustrate a possible flow of events in the embodiment of FIG. 2 or 3. FIGS. 5A-5C illustrate possible states of a screen 132 at a client computer 110. At step 410 of FIG. 4A, the user starts a browser 140 at client computer 110. The browser starts in a window 174.1 (FIG. 5A) of screen 132, and specifies a URL of a desired HTML document 160. The browser sends a request 136 (FIG. 1) to an address associated with the

URL. The request is routed to a server 210 which responds with the document 160. At step 414, augmenter 204 augments the document 160 with augment 220 which contains a reference (URL) to code 178, and more particularly to some initialization portion 178.0 (FIG. 5A). At step 418, browser 140 creates the document representation 170 and renders the document in window 174.1. In response to the augment 220, and more particularly to the reference to code 178.0, browser 140 starts an interpreter 182 (e.g. a plug-in; this may be a JavaScript interpreter or a Flash Player). At step 422, interpreter 182 fetches the code 178.0 (e.g. the interpreter may establish a TCP connection to server 150 and fetch the code over this connection). Of note, different steps do not have to be performed in the order shown, but may be performed in a different order and may overlap. As is known, the interpreter 182 may interpret the code and/or may compile part or all of the code into the machine code of processor 120 (FIG. 2) for faster execution. With regard to the TCP connection, TCP stands for Transmission Control Protocol, and it is described in the following IETF documents (IETF stands for Internet Engineering Task Force) that are incorporated herein by reference: RFC (Request for Comments) 675, RFC 793, RFC 1122, RFC 1323, RFC 1379, RFC 1948, RFC 2018, RFC 2581, RFC 2988, RFC 4614.

Code 178.0 starts executing, and checks (at step 426) and determines that no other instance of code 178 is being executed by the same user. This checking can be done by querying the server 150 for state data 510 (FIG. 5A). As known in the art, each of servers 150 and 210 has one or more processors and computer storage. Server 150 maintains, in its storage, state data 510 which represent the current state of execution of code 178 for each user. FIGS. 4A-4C illustrate the operation for a single user. In some embodiments, state 510 does not exist for the user at the stage of step 426, so server 150 informs code 178.0 that there are no state data for this user.

At step 430, code 178.0 uses browser API 186 to create a small overlay 190.0 in window 174.1, and displays a suitable icon (“hello” icon) in the overlay. The user may choose to ignore the icon.

At step 434, the user clicks on icon 190.0. In response (step 438), code 178.0 guides the user through a user authentication process with participation of server 150 (e.g. prompts the user to enter the user name and password and sends the name and password to the server; prompting the user may be skipped if the user name and password are cached on the client and obtained by code 178.0 from the client's cache). Upon successful authentication, code 178.0 loads another piece 178.1 of code 178 from server 150 if code 178.1 has not yet been loaded, and code 178.0 branches to code 178.1. Code 178.1 may be in the same language as code 178.0, or may be in a different language, perhaps requiring a different interpreter. In the example being described, it will be assumed for the sake of illustration that all of code 178 uses the same interpreter 182. At step 442, code 178.1 uses API 186 to create a larger overlay 190 in window 174.1 (FIG. 5B). In this overlay, code 178.1 may display icons of those programs 178 which are available to the user. The available programs may be defined by the user's profile kept on server 510. One of these programs may be a word processor (“WP”). The user clicks on the icon representing the word processor in overlay 190. In response, code 178.1 starts the word processor (step 446). We will assume for the sake of illustration that the word processor is implemented in code 178.1 though the word processor may be implemented in another piece of code hosted by server 150 or another server. Also, code 178 may create multi-window environment in overlay 190. FIG. 5B shows one window 520 created by code 178. For ease of reference, windows 520 will be called “augment windows” herein. The word processor may be executed in one or more of augment windows 520. Further, code 178 may create multiple overlays 190 in browser window 174.

At step 454, the word processor issues DOM calls via API 186 to insert suitable scripts into document representation 170. The particular scripts depend on the desired user interface to be provided. For example, suppose the user is to be allowed to copy images (IMG elements) from HTML document 160 into a word processing document 530 (FIG. 5B) by simply double-clicking on an HTML image. Then the following technique can be used if the WP is written in ActionScript.

(i) The WP code 178 includes an event-handler method which inserts images into the WP document 530. Let us suppose that this method is named “insert_image(img)” where “img” is a pointer to the image to be inserted into the WP document 530.

(ii) At the initialization stage, the WP calls ExternalInterface.addCallback( ), which is a call in standard ActionScript API, to associate the image handler “insert_image( ) with a JavaScript name to be injected into the HTML document representation 170. For the sake of example, let the JavaScript name be “call_WP_from_JS”. Then ExternalInterface.addCallback( ) can be called as follows:

ExternalInterface.addCallback(“insert_image”, “call_WP_from_JS”).

(iii) Still at the initialization stage, the WP injects JavaScript that makes calls to call_WP_from_JS when an image is double-clicked The injected JavaScript is to perform the following operations:

(a) get the list of all the image (IMG) elements by calling getElementsByTagName(“IMG”).

(b) for each element E in the list, define the element's double-click event handler as follows:

E.ondblclick=call_WP_fromJS(event).

This JavaScript is injected so as to be executed when the document representation 170 has been finished (e.g. the JavaScript may include the “onload” attribute).

At step 458, the user uses the word processor to create and edit a WP document 530 in augment window 520. The WP document 530 can reside on client 110 (storage 124), or server 150, or some other computer. (We will use the same term, “WP document 530” for the actual document and its representation in window 520.) The user double clicks on images in document 160 (area 194) to copy the images into WP document 530.

At step 462, the user instructs the browser to load another HTML document 160 (“second” HTML document) into window 174.1. This can be done by the user clicking on a hyperlink in area 194 of window 174.1, or the user entering the second document's URL into the address bar (not shown) in window 174.1.

At step 466, the second document 160 is fetched from a server 210, and augmented by augmenter 204. In this embodiment, the augmenter 204 performs the same augmentation (i.e. with the same augment 220) for all documents 160, so each document 160 is augmented with a reference to the same code 178.0.

Browser 140 clears window 174.1 and discards the document representation 170 for the first document. Browser 140 then repeats the steps 418-422 described above, and in particular creates document representation 170 for the second document and re-loads the interpreter 182 to handle the augment 220. The browser may also avoid re-loading the interpreter 182 but use instead the previously loaded copy of the interpreter. The interpreter fetches and executes code 178.0 from server 150. At step 470, code 178.0 obtains state data 510 from the server. Example state data are shown in FIG. 6 and described below. State data 510 identify each program 178 (e.g. word processor, email, chat) which is being executed by the user, and also describe each overlay 190 and each augment window 520. Upon receipt of state data 510, code 178.0 places the client 110 in the state defined by state data 510. This is the same state as in FIG. 5B except that the first document is replaced with the second document. In particular, code 178.0 loads code 178.1 which includes the word processor; code 178.1 and/or 178.0 uses API 186 to create overlay 190; code 178.1 creates the windows 520 defined by the state data 510, associates the windows with the programs (such as the word processor) as defined by state 510, and causes these programs to redisplay the content of each window 520. In particular, the WP's window 520 redisplays WP document 530 in the state in which it was displayed immediately before the user requested the second document. The WP also places the user interface (UI) into the state defined by state data 510. The UI state includes the cursor position (the point of insertion) in WP document 530 and may include other parameters which define how the user input will be processed (for example, the font of the input if the user enters text, the effect of the UNDO or REDO commands should the user enter such commands, and possibly other parameters). For each program, the state data may be program-dependent.

At step 474, code 178 repeats the step 454. More particularly, code 178 makes DOM calls via API 186 to inject JavaScript code into the second document's representation 170. The JavaScript code causes the code 178 to be informed, for each image in the document representation, when the user double clicks on the image. The code 178 copies the image into the WP document 530. In some embodiments, step 474 does not use state data 510. In other embodiments, state data 510 may be useful. For example, in some embodiments, the WP allows the user to define features of the user interface. The user may specify for example that the document copying should be performed on a single click, not a double click; or that double-clicking on a text paragraph (defined by the <p> tag) in HTML document 160 should result in copying the text paragraph into the WP document. In this case, the injected JavaScript code needs to inform the WP of the suitable events such as single clicking on an image or double-clicking on text. If the user desires to be able to use API 186 to drag and drop elements from HTML document 160 to WP document 530, the JavaScript should inform the WP of mouse-down, mouse-move, and mouse-out events. The user-defined UI is provided by state data 510, and is used to construct the JavaScript code injected into the browser.

In another example involving Flash Player 182, the user can use the mouse to resize overlays 190. The injected JavaScript code is constructed to provide mouse-down, mouse-move, and mouse-out notifications to code 178. Each notification includes the mouse cursor's position at which the event occurred. If the user uses the mouse to press on the border of overlay 190, the Flash Player generates a mouse-down notification for code 178 without using API 186, or the injected JavaScript sends a mouse-down notification to code 178 via API 186. Then the user moves the mouse to the desired position of the overlay border, and then releases the mouse button. Code 178 receives the mouse cursor's coordinates associated with the mouse-out event, computes the new position of the border, and issues a DOM call or calls via API 186 to cause the browser to resize the overlay.

At step 478, the user continues to edit WP document 530 in overlay 190. For example, the user may double click on images in the second HTML document 160 to copy the images into WP document 530.

At step 482, the user starts browser 140 in a different window 174.2 (FIG. 5C).

In the present embodiment, a new copy of the browser is loaded. In FIG. 5C, the software executed by the client in connection with window 174.1 is shown at 134.1, and the software executed by the client in connection with window 174.2 is shown at 134.2. All this software is in storage 124 (FIG. 2). In other embodiments, the windows 174.1, 174.2 may share some software. For example, the browser instances 140 may share all or part of their code. Code 178 and the interpreter code 182 may also be shared (code 178 and interpreter code 182 have not yet been loaded yet for window 174.2).

At the step 482, the user requests the browser 140/134.2 (i.e. the browser instance associated with window 174.2) to load a third document 160 into window 174.2. The browser 140/134.2 sends the third document's URL to the network.

At step 484, augmenter 204 augments the third document with the reference to code 178.0 as in step 466.

At step 488, the browser 140/134.2 creates document representation 170 for the third document and renders the third document in window 174.2. The browser also loads a new instance of interpreter 182 (interpreter instance 182/134.2 below) and passes to the interpreter the reference to code 178.0 in the third document. The interpreter fetches code 178.0 from server 150 and executes the code. These operations are performed as described above for step 418-422 (for the first document) and 466 (for the second document).

At step 492, code 178.0/134.2 (i.e. the instance of code 178.0 in software 134.2) fetches state data 510 from server 150 and/or from the local storage 124 on client 110 (if the code 178/134.1 cashed the state data on the client). Code 178.0/134.2 detects the interpreter instance 182/134.1 from the state data 510. In some embodiments, the interpreter instance 182/134.1 can also be detected by code 178.0/134.2 using services provided by the interpreter. For example, if the interpreter is the Flash Player, then the LocalConnection API can be used to detect the interpreter 182/134.1.

Code 178.0/134.2 then sets up, in window 174.2, the state indicated by the state data 510. In particular, overlay 190 is created in window 174.2, and another instance of code 178.1 with the word processor is loaded from server 150. The word processor for window 174.2 uses the browser API 186 to cause the browser 140/134.2 to modify the document representation 170 of the third document 160 to inform the word processor of the events pertaining to the third document. An example of such event or events are the user double-clicking on images from the third document the images to the word processor's augment window 520 in overlay 190 in browser window 174.2. These steps can be performed as described above in connection with steps 454, 474.

At step 496, the user copies images from the third document 160 into WP document 530 by double-clicking on the images into the augment window 520 in browser window 174.2. Any changes to WP document 530 are recorded by code 178/134.2 in state data 510 on server 150. All changes to state 510 are broadcast by server 150 to all the instances of code 178 that are associated with the same user. In response, each instance of code 178 updates its overlay(s) 190. Therefore, the augment window 520 in browser window 174.1 is current. The user can switch between the windows 174.1, 174.2 to edit the same WP document 530 and in particular to copy elements from the second and third HTML documents 160 into the WP document. All changes to WP document 530 that are made in one of the two overlays 190 are propagated to the other overlay via state data 510.

The user may start a browser on a different client 110 (“second client”). When the browser fetches a document on the second client, augmenter 204 augments the document with code 178.0. Then the steps 414-438 are performed on the second client. In the authentication operation (step 438), server 150 matches the second client's browser with the first client's browser instances, and from that point on the server sends the state 510 and any changes in state 510 to the second client. The user can now edit the same WP document 530 from the second client. All the changes to WP document 530 are propagated to the first client's overlays 190 via state 510 in the same way as they are propagated from one overlay to the other on the same client. The user may open the browser in any number of windows 174 on any number of clients 110. All the overlays on all the clients display the same images as determined by state 510.

The user can start any number of programs in code 178 on any client in any number of augment windows 520. Each overlay 190 will still have the same visual state, i.e. display the same image provided that the windows 174 are sized to the same size and the clients 110 have the same video capabilities. (If the video capabilities are different, the images may look different; for example, a client's black-and-white monitor cannot display the colors displayed on a color monitor; however, the images displayed will be defined by the same image data defined by state data 510.)

In some existing systems, the reach of browser API 186 is limited for security reasons. For example, a code instance executed for an HTML document associated with one window 174 may be unable to access, via browser API 186, the document representation 170 associated with another window 174. Further, even if two HTML documents are loaded at different times into the same window 174, a code instance executed in connection with one of the HTML documents may be unable to access the document representation of the other HTML document. In the embodiment of FIGS. 4A-4C, this security restriction is in effect bypassed. For example, even though the code instance 178/134.1 cannot use browser API 186 to access document representation 170/134.2, the document representation 170/134.2 can be accessed via browser API 186 by code 178/134.2, and the state of code 178/134.2 is propagated to code 178/134.1 via state data 510. This is convenient for the user because in some operating systems the browser API 186 is more powerful for at least some tasks than other available interfaces. For example, browser API 186 may provide better format conversion when an image is copied from an HTML document 160 to WP document 530. Even though the security restriction is bypassed, the security risks may be acceptable if, for example, code 178 is provided by a trusted party.

FIG. 6 illustrates exemplary structure of state data 510 for a single user. Each instance of code 178, on each client 110, is identified by data block 604. For example, in some embodiments, each instance of code 178 establishes and maintains a TCP connection to server 150, and each data block 604 identifies the TCP connection (e.g. by the IP address and TCP port of code instance 178).

Further, a separate block 610 of data is kept for each application program 178, such as the word processor, the email, and the chat program. Also, a data block 620 is provided for each overlay 190. (There may be multiple overlays 190.) Data block 620 stores the corresponding overlay's coordinates in the browser window 174, the overlay's height and width, and perhaps other properties (e.g. the overlay's transparency). For each augment window 520, a data block 630 identifies the corresponding overlay 190, the augment window's size and position in the overlay, and possibly other properties. In some embodiments, only one copy of data 610, 620, 630 is provided.

For each application 178, the block 610 identifies the application's overlay(s) 190 and augment window(s) 520, and includes other data defining the augment windows' contents and providing application-specific information defining the application's state. For example, for the word processor, the block 610 may identify WP document 530, which portion of the WP document is being displayed, the cursor position, etc.

Some of state data 510 may be associated with a particular window 174 and not propagated to the other windows. For example, suppose the user re-sizes or moves an overlay 190 in a window 174. If the position and size of overlay 190 are propagated to all windows 174, then the change in the overlay's size or position will be reflected in all the windows. In some embodiments however, the overlay's size and position are provided separately for each window 174. Hence, the overlay 190 can be sizes and positioned differently in different windows as needed, for example, to view desired portions of the respective HTML documents (different windows 174 may display the same or different HTML documents). If the user starts a new instance of the browser in some window 174 for which no state data has been kept, then the overlay size and position can be copied for this window from the state data for another window, or may be initialized to some predefined values reserved for new instances of the browser.

One implementation will now be described in which code 178 includes a chat program and at least part of code 178 is JavaScript and another part is action codes interpreted by the Flash Player. The steps performed are labeled below as (C1), (C2), etc.

(C1) Every webpage (every HTML document 160) is augmented with augment 220. Suppose the document 160 initially has the following content:

Listing 1: Initial HTML Document

<HTML>
<HEAD>
<SCRIPT src=“http://...”> <!-- This script is in the initial HTML
document -->
</HEAD>
<BODY>
<P>This is the visible user content</P>
</BODY>
</HTML>

Augmenter 204 augments both the HEAD section and the BODY section to produce the augmented document delivered to browser 140 and shown in Listing 2 below. The line numbers in Listing 2 are not part of the augmented document. The augment 220 is in lines 4-8 and 11-19.

Listing 2: Augmented HTML Document

| | |
|---|---|
| 1. | <HTML> |
| 2. | <HEAD> |
| 3. | <SCRIPT src=“http://...”> <!-- This script is in the initial HTML document --> |
| 4. | <!-- Begin head section augmentation, using references to JavaScript portion |

of code 178.0 on server 150-->

| | |
|---|---|
| 5. | <script src=“http://static.example.com/r/38/assets/js/swfobject.js”></script> |
| 6. | <script |

src=“http://static.example.com/r/38/assets/js/jquery_1.2.6.js”></script>

| | |
|---|---|
| 7. | <script |

src=“http://static.example.com/r/38/assets/js/example_head.js”></script>

| | |
|---|---|
| 8. | <!-- End head section augmentation --> |
| 9. | </HEAD> |
| 10. | <BODY> |
| 11. | <!-- Begin body section augmentation; using inline JavaScript --> |
| 12. | <script type=“text/javascript”> |

| | |
|---|---|
| 13. | if( window == top ) |
| 14. | { |

| | |
|---|---|
| 15. | // Invoke JavaScript function defined in example_head.js from HEAD |

section above

| | |
|---|---|
| 16. | _{——}ykr_js_export_example_inline_body_init_preWrapper( ); |

| | |
|---|---|
| 17. | } |

| | |
|---|---|
| 18. | </script> |
| 19. | <!-- End body section augmentation --> |
| 20. | <P>This is user-visible content</P> |
| 21. | </BODY> |
| 22. | </HTML> |

The three hyperlinks in lines 5-7 (http:// . . . js) are URLs of code pieces 178 on server 150.

(C2) As soon as the browser finishes the bare minimum initialization for the webpage (i.e. for the document 160), such that the browser is ready to interpret the first line of the user-defined JavaScript in the webpage, the example inline_body_init_preWrapper( )method will be called by the browser (i.e. by the JavaScript interpreter plug-in invoked by the browser to interpret the JavaScript). This method is defined in code 178 at server 150 at http:// . . . /example_head.js (line 7 in Listing 2). This method is defined as follows:

Listing 3:

| | |
|---|---|
| 1. | function example_inline_body_init_preWrapper( ) |
| 2. | { |

| | |
|---|---|
| 3. | inject_settingsManagerSWF( ); |
| 4. | inject_mainSWF( ); |
| 5. | inject_chatWindowSWF( ); |

| | |
|---|---|
| 6. | } |

This function causes three Flash Player instances to be “attached” to the current web page (i.e. associated with a single instance of browser 140; the three Flash Player instances correspond to a single Flash Player instance 182 in FIGS. 4A-4C). The three Flash Player instances become loaded in the same way, and only one instance will now be described which is associated with inject_mainSWF( ) in Listing 3 line 4. The method inject_mainSWF( ) is defined on server 150 as:

Listing 4:

| | |
|---|---|
| 1. | function inject mainSWF( ) |
| 2. | { |

| | |
|---|---|
| 3. | var str_embed_main = “<object id=”‘+_ykr_g_str_mainSWF_domId+’“ |

width=‘100%’ height=‘100%’ align=‘left’” +

| | |
|---|---|
| 4. | “ classid=‘clsid:D27CDB6E-AE6D-11cf-96B8- |

```
  444553540000’>” +
  5.
```

| 6. | “<param name=‘AllowScriptAccess’ value=‘always’>” + | |
|---|---|---|
| 7. | “<param name=‘AllowNetworking’ value=‘all’>” + | |
| 8. | “<param name=‘swliveconnect’ value=‘true’>” + | |
| 9. | “<param name=‘movie’ | value=“‘ + |

```
  _ykr_g_str_STATIC_CONTENT_URL_PREFIX +
  ”/assets/swf/example_client_main.swf’>” +
```

| | | |
|---|---|---|
| 10. | “<param name=‘wmode’ | value=‘transparent’>” + |

| | |
|---|---|
| 11. | “<param name=‘flashvars’ |

```
  value=‘windowId=1&swfId=“+_ykr_g_str_mainSWF_domId+”&rootViewClassName=
  main’/>” +
12.
```

| 13. | “<embed width=‘100%’ height=‘100%’” + | |
|---|---|---|
| 14. | “ | src=“‘ + _ykr_g_str_STATIC_CONTENT_URL_PREFIX |

+ ”/assets/swf/example_client_main.swf”’ +

| | | |
|---|---|---|
| 15. | “ | wmode=‘transparent’” + |

| | |
|---|---|
| 16. | “ |

```
  flashvars=‘windowId=1&swfId=“+_ykr_g_str_mainSWF_domId+”&rootViewClassNa
  me=main’” +
```

| | | |
|---|---|---|
| 17. | “ | allowScriptAccess=‘always’” + |
| 18. | “ | allowNetworking=‘all’” + |
| 19. | “ | swliveconnect=‘true’” + |
| 20. | “ | type=‘application/x-shockwave-flash’>” + |

| | |
|---|---|
| 21. | “</embed>” + |

| | |
|---|---|
| 22. | “</object>”; |

23.
24.

| | |
|---|---|
| 25. | var str_mainSWF_container = |

| | |
|---|---|
| 26. | “<div id=‘_{——}ykr_dom_mainSWF_container’ |

```
  style=‘visibility:visible;position:fixed;top:0;left:0;width:150px;height:25px;z-
  index:2147483501;’>” +
```

| | |
|---|---|
| 27. | str_embed_main + |

| | |
|---|---|
| 28. | “</div>”; |

29.

| | |
|---|---|
| 30. | document.write(str_mainSWF_container); |

| | |
|---|---|
| 31. | } |

In Listing 4 line 30, document.write( ) is a browser-defined method (i.e. defined by browser API 186) which adds str_mainSWF_container to the webpage's DOM. The str_mainSWF_container includes the <OBJECT> element str_embed_main (line 27) defined by the <OBJECT> tag in lines 3-22. The <OBJECT> element becomes thus added to the DOM. As a side note, document.write( ) is good to use here, because the function inject_mainSWF( ) was invoked from an inline script at the start of the <BODY> section (Listing 2 line 7). If we were to invoke document.write( ) at a later point in time, when the full webpage DOM has been built by the browser and the onLoad( ) JavaScript event has fired, then our document.write( ) would completely *replace* the entire webpage's contents. If we wanted to do this at a later point in time, we would use the document.createElement( ) call. However, using this call is slower in terms of performance on most modern browsers, so we use the approach above (the document.write( ) method), and for the sole purpose of being able to use it, we have our augmentation at the start of the <BODY> section. If we did not care about performance, we would not need to augment the <BODY> section of the webpage.

(C3) When the browser executes the document.write( ) call, the <OBJECT> element is added to the DOM. The addition of this element causes the browser to then interpret the meaning of the <OBJECT> element's attributes, and more specifically the classid attribute (Listing 4 line 4). On Microsoft Windows (Trademark) systems, when the browser sees a classid, it looks up the ActiveX control with this ID in the Windows Registry, creates an instance of the ActiveX control, and makes the ActiveX control available to the browser. On some other operating systems a different underlying strategy is used to create instances of browser plug-ins, but the classid identifier remains the same across all operating systems. (This is the case for modern browsers; legacy browsers of type Netscape 4+ (Trademark) used <EMBED> instead of <OBJECT>.)

(C4) The specific classid of clsid:D27CDB6E-AE6D-11cf-96B8-444553540000 corresponds to the Flash Player. As a result, interpreting the above <OBJECT> tag causes the browser to create an instance of the Flash Player as interpreter 182. The browser then examines all the <param> elements, and passes all the name/value pairs to the newly-created Flash Player instance. (This is true for typical browser plug-ins. They would all receive the set of name/value pairs defined as children of the <OBJECT> element.)

(C5) After the browser creates the Flash Player instance 182, and passes to the Flash Player the name/value pairs, the browser then invokes an initialization method on the Flash Player, as it would with any other plug-in/ActiveX object.

(C6) In the case of the Flash Player, this initialization method reaches out to the browser, and looks at the <OBJECT> element's width and height attributes (Listing 4 lines 13, 26). Using the values defined by these attributes, the Flash Player then requests a drawing surface (an overlay 190) of this size from the browser. Alternatively, the browser may pre-allocate the drawing surface 190 based on the <OBJECT> element's attributes, and pass the definition of the drawing surface 190 to the Flash Player instance. In either case, the effect is the same—the Flash Player gets an overlay 190 with the appropriate rectangular dimensions.

(C7) The Flash Player's initialization method then looks at the movie name/value pair (Listing 4 line 9) which was passed to the Flash Player. In the example above, the value of this name/value pair is the following URL: “http://static.example.com/r/38/assets/swf/example_client_main.swf”. (Even though in Listing 4 the value is defined as _ykr_g_str_STATIC_CONTENT_URL_PREFIX+“/assets/swf/example_client_main.swf, string concatenation occurs at JavaScript evaluation time before the <OBJECT> element is ever constructed by the browser.)

(C8) The Flash Player then fetches the SWF file 178 located at the URL specified by this value. (An “SWF file” is a file with action codes compiled from ActionScript.) The URL corresponds to a file on server 150.

(C9) The SWF file is comprised of a short header (to identify the file as a SWF and its version number) and a number of tags. Each tag is either a Definition Tag or a Control Tag. A Definition Tag contains within it the raw bytes for a resource such as an image, a font, the vector data for a vector-based drawing, or another similar resource. A Control Tag contains within it a variety of things, including notably the instructions in action codes.

(C10) As soon as the Flash Player has streamed in the “minimum portion” of a SWF file, the Flash Player immediately begins action codes execution. This means that as soon as the Flash Player encounters the end of a Control Tag and discovers that this Control Tag contains action code instructions, the Flash Player immediately starts executing these instructions without waiting for subsequent Control Tag(s) to arrive from the network. (In Flash Player 9+, these bytecodes are “run” in a hybrid interpreted/executed mode similar to Java Virtual Machines. That is, the “hotspots” or methods which take up the most computation time are dynamically compiled down to native machine instructions, on the fly by the Flash Player, and subsequent invocations to these methods use the compiled instructions instead of using the interpreter.)

(C11) At this point, the ActionScript code 178 starts running The above steps describe what happens when a single Flash Player instance is added to the webpage. However, in the embodiment being described, three instances are added to the webpage, as visible from the example_inline_body_init_preWrapper( ) method definition above (Listing 3 lines 3-5). The first instance will be referred to herein as a “settings.swf” (i.e. “inject_settingsManagerSWF( )” in line 3), the second instance will be referred to as “main.swf” (line 4), and the third instance as “chatWindow.swf” (Line 5). Because multiple Flash Player instances 182 for a given webpage are often initialized concurrently, the settings.swf is a performance optimization. It's a small SWF file, which contains no Definition Tags and a very small amount of code in one Control Tag. As a result, bytecode execution begins almost immediately for this file as the first (and only) Control Tag end is streamed in to the Flash Player.

(C12) When this happens, the code in settings.swf uses the standard Flash Player LocalSharedObject API to get some settings which are part of state data 510. These settings can also be cached at the client 110. Therefore, settings.swf reads some data from the client's disk 124 on client 110. This data contains the initial settings required to properly configure the visual appearance of main.swf. (The LocalSharedObject API is described in more detail in [R8].) If this data is not present on the client's disk 124 (because either it is a brand new user, or the user manually deleted the corresponding Flash cookie file on the disk), the data is initialized to appropriate defaults from either (a) hard-coded values contained within the bytecode of settings.swf or (b) values fetched from server 150.

(C13) When the code in main.swf starts executing, the first thing it does is ask the settings.swf Flash Player instance 182 for the initial settings. The communication between main.swf and settings.swf is done using the standard Flash Player LocalConnection API. A description and example of this API is available in [R9].

(C14) In some embodiments, the initial settings data contains the current user's GUID (”globally unique identifier” for server 150; the GUID is part of state data 510 for the user if the user is “logged in”; the log-in occurs at authentication at step 438).

The initial settings data also specify how the overlays 190 should be displayed. In the embodiment being described, the chat program uses two overlays 190 in browser window 174. One overlay 190 displays the names of users (“buddies”) who are available for the chat, and the other overlay displays the number of users available for the chat. One of these two overlays is used by the main.swf and the other of the overlays is used by the chatWindow.swf. The initial settings data include data 620 (FIG. 6) which specify whether to display the overlay 190.0 (the “hello” overlay) as in FIG. 5A, or whether to display the two overlays for the chat program.

(C15) When the code in chatWindow.swf (Listing 3 line 5) starts executing, it establishes a LocalConnection to main.swf to figure out whether chatWindow.swf should make itself visible and whether to show the login screen for the chat program or a list of buddies for the chat program. In the case of a list of buddies, the main.swf will tell chatWindow.swf what the list of people is. In other embodiments, the chatWindow.swf could just as easily have asked settings.swf for its initial visibility state, and main.swf for the buddy list information. The reason main.swf is asked for the buddy list information is that main.swf is the only SWF on the webpage that establishes a socket connection to the server 150. From that point forward, all communication with the server 150 is done through main.swf for that particular browser window 174 (or browser tab; a browser 140 may define a number of tabs in window 174, and present a different document 140 in each tab; from the user's prospective, each tab looks like a separate window 174, with a separate browser instance running in each tab).

(C16) There are race conditions possible during steps (C8)-(C15) due to the fact that the three Flash Player instances associated with Listing 3 are initialized (and subsequently fetch the SWF files (“SWFs”) and start executing the action codes) concurrently. For example, if main.swf finishes loading before settings.swf (which almost never happens in some embodiments, and in this regard the settings.swf is used as a separate SWF file for performance optimization), main.swf will have to wait until settings.swf has (a) fully loaded and (b) had a chance to read from the client's disk 124 to receive the initial settings. As a result, main.swf first registers a listener on the LocalConnection and then tries to send a request for the initial settings on that LocalConnection. If settings.swf has already loaded and executed, its LocalConnection event handler will fire in the settings.swf Flash Player instance, and settings.swf will respond with the appropriate initial settings data. On the other hand, if settings.swf has not yet loaded and/or finished executing, then main.swf will simply wait for a message to arrive on the LocalConnection. The settings.swf will always send initial settings on the LocalConnection (upon startup) in addition to responding to any requests for this state. If main.swf ever receives this information in its LocalConnection listener after main.swf has already finished its request to settings.swf, this redundant information is simply ignored.

Another race condition occurs when chatWindow.swf finishes loading before main.swf, and starts execution. Because chatWindow.swf relies on information from main.swf to render chatWindow.swf's visual appearance properly, chatWindow.swf will use the same technique of “knock, knock ask . . . and if no one's there, wait for its LocalConnection listener to be fired instead” as described immediately above for main.swf. In other words, chatWindow.swf will request main.swf for the desired information and wait for the response or for the main.swf sending the information on the LocalConnection by default when the information becomes available.

(C17) Once main.swf and chatWindow.swf have received their initial settings, each of these two SWF programs has enough information in local memory 124 to affect the SWF program's visual state accordingly. The above is what happens in the case of one browser window or tab 174.

(C18) In case of multiple browser windows/tabs 174 on the same or multiple clients 110, two exemplary approaches can be used.

(C18a) One approach is to use, on each client 110, the client's disk 124 as a cache for storing settings data for browser windows/tabs 174 on that client 110, and to user the server 150 for all other clients 110 being used by the user. In this case, any change to visual state (i.e. to the overlays 190) in one browser window/tab 174 will cause the corresponding SWF program in which the visual change happened to report to settings.swf the updated state such that the updated state can be immediately written to disk 124 and asynchronously sent to server 150. The server updates the state data 510 and sends the updated state to every other browser instance 140 as defined by data blocks 604 (FIG. 6), or at least to every other browser instance associated with the other clients 110. More particularly, after the settings data has been flushed to disk 124, a special LocalConnection is used by settings.swf to broadcast to the settings.swf's client 110 and server 150 the fact that settings data has changed. The broadcast also identifies the settings.swf's client 110 on which the settings data has changed. Other SWFs in other/existing browser windows/tabs 124 on the same client 110 will then see a LocalConnection event, and query their settings.swf for the appropriate, refreshed data from disk 124. Given this new data, the SWFs in the other tabs may either repaint their entire visual appearance in overlays 190 in accordance with this state, or compute only what is different and change only those portions of their overlays 190 which have changed. The logic to update the visual appearance is application specific. However, the logic to detect changes is generic, in that it walks the settings data structures in memory, compares each value from the new settings to the old ones, and fires a local change event to the UI component tree. The application-specific logic in each component/application then responds to this UI state change event to update its visual appearance, if needed.

If the user creates new windows/tabs 174 on a client 110 on which the SWFs 178 are already running, then for any SWF(s) 178 associated with any new window/tab 174, the SWF(s) will receive the updated state by reading it from the disk 124 via settings.swf during their regular initialization as described in the steps (C12)-(C15) above.

(C18b) Another approach is similar to (C18a), but *always* uses the server 150 as the store for settings data 510. (The client's local disk 124 is never used for the settings data 510 in this case beyond a user GUID used to bootstrap communications with the server 150 for a “logged in” user.) In this approach, when any visual state changes in a SWF's overlay 190, the SWF immediately reports this change in settings data 510 to the server 150 (via main.swf associated with that browser window/tab 174, since only main.swf maintains a socket connection to the server 150.) The server 150 maintains the list 604 (FIG. 6) of all Flash Player main.swf instances connected to the server (one for each browser window/tab 174 for a given user, for all browser windows/tabs the user has open on *all* clients 110), and the server sends this updated settings data 510 to all connected main.swf Flash Player instances 182 for the user. Upon receiving this updated settings data 510 from the server, each main.swf associated with a browser window/tab 174 is then responsible for notifying all SWF(s) for that browser tab/window that settings data 510 has changed. This can be done via either the LocalConnection or ExternalInterface APIs.

(C19) To further clarify this last point, SWFs within a given browser tab/window 174 can communicate using either LocalConnection or ExternalInterface. The LocalConnection and ExternalInterface are almost interchangeable when the communication is between two SWFs in the *same* browser tab/window 174. As a result, some embodiments of the client-side code 178 have a MessageBus abstraction that allows either LocalConnection or ExternalInterface to be used for such communication associated with the same browser tab/window 174.

(C20) The MessageBus abstraction (described for example in Hohpe, Gregor and Bobby Woolf, “Enterprise Integration Patterns: Designing, Building, and Deploying Messaging Solutions” Addison-Wesley, 2003, incorporated herein by reference) either uses a LocalConnection as described in [R9], or uses an ExternalInterface in a novel fashion. In the case of ExternalInterface, the MessageBus (which is implemented as identical ActionScript code in each SWF) uses a piece of JavaScript that (a) maintains a list of all SWF clients that it is told about and (b) knows how to take a “message” it is given, and broadcast it to all other SWF clients on the list. The JavaScript code is shared by all the SWFs associated with a single browser window/tab 174. For the SWFs associated with the window/tab 174, the corresponding JavaScript code receives a message from such a SWF by means of the SWF's MessageBus code making a call, via ExternalInterface, from ActionScript to JavaScript. Because ExternalInterface automatically serializes/deserializes arbitrary data structures between the Flash Player instance's memory (unique to each Flash Player instance in storage 124), and JavaScript interpreter memory (common to everything on a single browser tab/window 174), the message can be arbitrarily complex. Some embodiments simply pass the settings data 510 as such a message. When the JavaScript code iterates over the list of all the SWFs it knows about (since previous calls were made to the JavaScript code to inform it of them when each Flash Player instance 182 associated with the same window/tab 174 started running), the JavaScript code simply invokes on each SWF client a Message us-defined method and passes the same data structure 510 that was given to it. In this fashion, all SWFs in a given browser tab/window 174 quickly receive the settings data 510.

Augmenter 204: In some embodiments, augmenter 204 is implemented as a proxy for the TCP connections. In other embodiments, the augmenter is invisible (transparent) to the TCP traffic between clients 110 and internet 112. As is well known, browsers 140 use TCP connections to communicate with servers 150, 210. The transparent augmenter does not use its IP addresses on such connections. Further, each browser request for an HTML document and each HTML document may be transmitted as multiple TCP packets on a TCP connection. In some embodiments, the augmenter buffers the TCP packets for each HTML document until the whole document is received and augmented with augment 220, and the augmenter retransmits the packets only after the augmentation. For example, the augmenter may reconstruct the HTML document, augment the document, and then transmit the document. In other embodiments, to speed up the document delivery to the user, the augmenter may re-transmit the TCP packets before the augmentation is completed. An exemplary embodiment of such an augmenter 204 will now be described. This augmenter is transparent in this embodiment. For a listing of the augmenter's software in source code, in the C programming language, see Appendix 1 of the aforementioned U.S. priority provisional patent application No. 61/328,571.

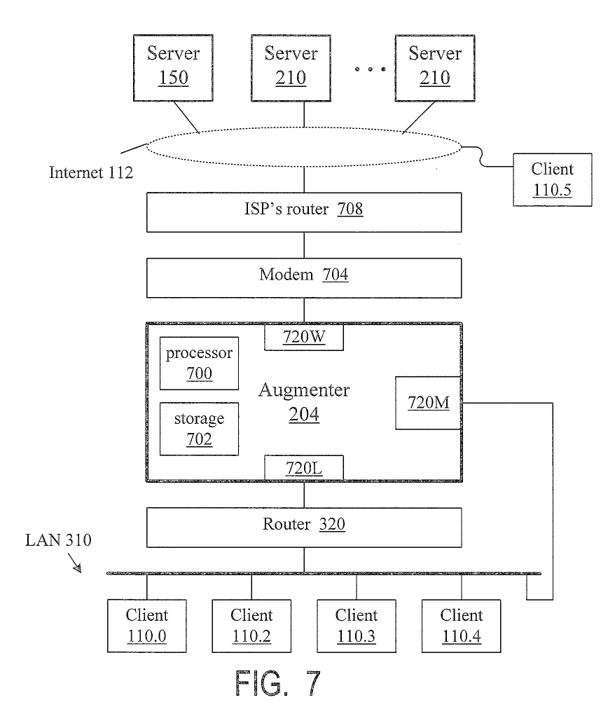

The augmenter can be an “appliance” connected as in FIG. 3. The augmenter contains its own processor or processors 700 (FIG. 7) and its own storage 702 which stores the computer programs described in Appendix 1 of the aforementioned U.S. patent application No. 61/328,571 and executed by the processor 700. The computer programs' source code (Appendix 1 of the aforementioned U.S. patent application No. 61/328,571) includes the file example_packet_handler.c containing the programming logic, and the file example_packet_handler.h defining some data structures used by the programming logic.

For each incoming TCP packet, P, the augmenter applies the following logic, with all the action starting in example_handle_tcp_packet( ) in file example_packet_handler.c:

(A1) The augmenter obtains, from the packet P, the IP source address “ip_src”, the IP destination address “ip_dst”, source TCP port “tcp_src”, and destination TCP port “tcp_dst”, and hashes the {p_src, ip_dst, tcp_src, tcp_dst} tuple, using the FNV_{—}32 hashing algorithm to generate a key, P_key [in example_create_conn_entry_key( )].

(A2) Uses P_key to get or create the associated connection entry, CE in a global hash table, GHT.

(A2a) If GHT(P_key) doesn't exist, *and* P's SYN flag is set in the packet's TCP header (the SYN flag indicates that this is the first packet sent by the P's source on the TCP connection), then a new CE is created. This means a new TCP connection was detected by augmenter 204. If P's SYN flag is not set, this represents the middle of an existing TCP connection, where the augmenter 204 was not monitoring the network at the time of that TCP connection's setup. (This logic is meaningful in view of a well-known three-way TCP handshake.)

(A2b) If GHT(P_key) does exist, then this packet is 2 . . . N (i.e. one of the second through Nth packets where N is some number) of the connection identified by the CE [in example_get_or_create_conn_entry( )].

(A3) Given the existing (or newly created) CE, the augmenter takes note of the direction in which P is travelling—upstream or downstream. Upstream is defined as when the P ingress is the LAN port (the port connected to LAN 310) and the P egress is the WAN port (the port connected to the Internet 112). Similarly, downstream is defined as when P ingress is on the WAN port, and P egress is on the LAN port. Given P's direction, augmenter 204 pulls out the corresponding flow structures from the CE, flow and opposite_flow. There are only two flows possible, CE→downstream and CE→upstream. [in example_determine_flows( )].

(A4) If the flow has been previously augmented (by either modifying a packet, or inserting extra packets) with any data in augment 220, such that extra bytes were inserted into the TCP stream, augmenter 204 immediately fixes up P's SEQ and ACK numbers by the appropriate offset and -offset amounts respectively. [in example_fixup_seq_and_ack_in_packet( )]

(A5) Computes relative (1-based, i.e. starting at 1) SEQ and ACK numbers for P, given the initial sequence numbers (ISNs) picked at the start of the TCP connection [in example_compute_relative_seq_and_ack_numbers( )].

(A6) Given P's SEQ number, ACK number, and window_size, recomputes the amount of space (in bytes) left in the current TCP window for this flow [in example_update_tcp_window_metrics( )]

(A7) The CE keeps track of the current “connection state”, which is one of INITIAL, HTTP_GET_DETECTED (i.e. the HTTP GET statement has been detected which requests a resource and specifies the resource URL), DONE_NO_HTTP_GET_DETECTED, PARSING_HTTP_HEADERS, INSPECTING_HTML_RESPONSE, and DONE_ABORT_ALL_INSPECTION. (defined in enum ykr_conn_state)

(A8) If the CE's current state is either of the two end-states (DONE_NO_HTTP_GET_DETECTED or DONE_ABORT_ALL_INSPECTION), or if P contains an empty TCP body, then P is passed through augmenter 204 without any further processing for P. (That is, if P was ingress on the WAN port, it will egress on the LAN port unmodified, and if P was ingress on the LAN port, it will egress on the WAN port unmodified.) An “empty TCP body” is defined as a TCP packet which only has the TCP header, but nothing after it. Such packets are common to adjust TCP connection settings and or ACK (acknowledge) other packets, without actually transmitting any information.

(A9) At this point, if augmenter 204 is still doing processing for P, it means that P has a non-empty TCP body.

(A10) The TCP body of P is inserted into a “netbuf” structure (defined in struct ykr_netbuf), which represents a stream-oriented view of the cumulative TCP bodies we see over time on a single TCP connection, for a given flow. (Upstream and downstream flows each have a separate netbuf). [in example_insert_into_netbuf( )]

(A11) An unmodified copy of P is inserted into a “buffered packet list” (implemented as a linked list, and defined in struct ykr_buffered_packet_list.) The purpose of this list is to provide fast/convenient access to previously seen packets, as sorted by each packet's SEQ number. (Since all packets on this list have non-empty TCP bodies, the SEQ number represents the offset into a stream-oriented view of what is being transmitted on the flow.) [in example_insert_into_buffered_packet_list( )]

(A12) Given the current packet P, its effect on the CE's “connection state” is computed [in example_compute_conn_state( )]

(A13) At this point, if P is a packet traveling in the upstream direction, it is immediately transmitted on the WAN interface. Augmenter 204 never modifies upstream packets (with the exception of simple SEQ/ACK number fixups after an augmentation has taken place for a connection deemed to be carrying HTML.) [on line 1854 of example_packet_handler.c]

(A14) At this point, if P is a packet traveling in the downstream direction, the “current state” of the CE is checked.

(A14a) If the CE's “current state” is INSPECTING_HTML_RESPONSE, then the netbuf (a stream-oriented view of the TCP flow in a given direction) is inspected, and the appropriate augmentation steps are taken by modifying and/or adding packets to the “buffered packet list” described in (A11) above. [on line 1859 of example_packet_handler.c]

(A14b) If the CE's “current state” is anything other than INSPECTING_HTML_RESPONSE, then P is *not* transmitted on the LAN interface. Instead, it is considered “buffered” until further packets arrive to cause CE's “current state” to transition to INSPECTING_HTML_RESPONSE. [on line 1886 of example_packet_handler.c]

The logic for (A13) through (A14b) can be seen in example_handle_tcp_packet( ), immediately following the “example_checkpoint(“example_update_conn_info( ) done.”)” logging statement.

An HTML document 160 may be compressed by some compression method. In this case, augmenter 204 decompresses the document to insert the augment 220. In some embodiments, augmenter 204 re-compresses the augmented document using the same compression method or a different compression method. In other embodiments augmenter 204 sends the augmented document uncompressed to client 110.

The browsers' requests for HTML documents and the HTML documents themselves can be transmitted using HTTP (hypertext markup transfer protocol). HTTP is described, for example, in “Nov. 26, 2009; Draft -08 of the revised HTTP/1.1 specification” published by W3C, incorporated herein by reference, available at http://www.w3.org/Protocols/. HTTP allows chunked transfer encoding of messages. Thus, the HTML document 160 may be transmitted in chunks. Each chunk includes the chunk length, but there is no number specifying the total length of the document. If augmenter 204 augments a chunk, augmenter 204 increments the chunk's length.

Augmenter 204 may be connected into the overall system in many configurations as shown, for example, in FIGS. 3 and 7. In these figures, the augmenter is connected between router 320 and the Internet 112. The example of FIG. 7 includes a modem 704 (e.g. DSL or cable modem) connected to the augmenter's WAN port 720W. An Internet Service Provider's router 708 connected modem 704 to the Internet The augmenter's “LAN” port 720L is connected to LAN 310 through router 320. Other configurations are also possible.

In FIG. 7, clients 110 include clients 110.1-110.4 connected to LAN 310, and also include a client 110.5 not connected to the LAN. Client 110.5 augments the HTML documents using software implemented on the client itself or on an intermediate device (not shown) connected between client 110.5 and the Internet. Server 150 sends the state data 510, and any changes thereto, to all the clients 110 that are being operated by the same user.

As stated above, in some embodiments the augmenter 204 is transparent in the sense that it does not change the packets' IP addresses, and in some embodiments does not even change the packets' MAC addresses. However, this transparency makes it difficult or impossible to access the augmenter 204 remotely, over the Internet 112, for management purposes, e.g. to update the augmenter's software (such as shown in Appendix 1 of the aforementioned U.S. patent application No. 61/328,571) or to debug the augmenter. To facilitate remote management, the augmenter of FIG. 7 is provided with a separate port (management port) 720M which uses its own IP and MAC addresses to receive and transmit network traffic. Port 720M is connected to LAN 310. Therefore, augmenter 204 is accessible over the Internet in the same way as clients 110.

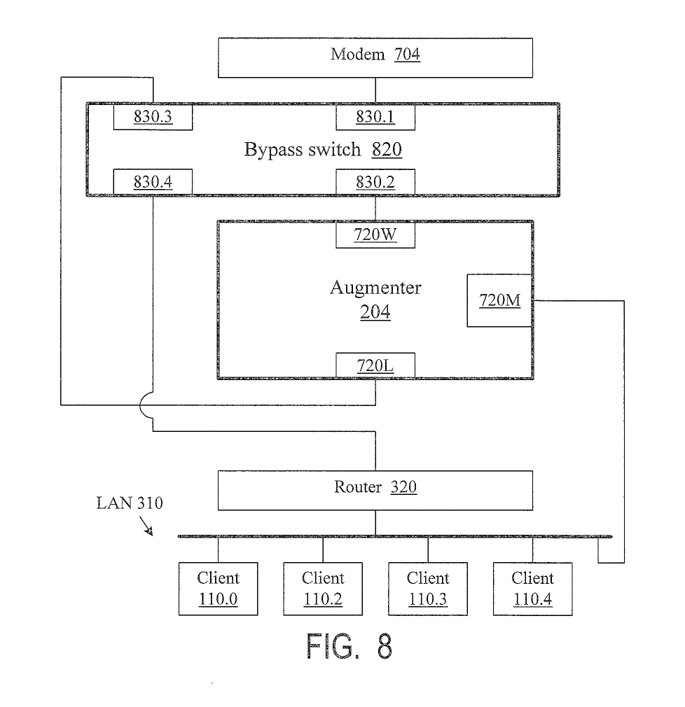

FIG. 8 shows another configuration which includes a bypass switch 820 to keep the traffic flowing around the augmenter if the augmenter fails. Switch 820 includes bidirectional ports 830.1-830.4, and in normal operation logically connects port 830.1 to port 830.2 and connects port 830.3 to port 830.4. Port 830.1 is connected to the Internet (through modem 704 for example), port 830.2 is connected to the augmenter's WAN port 720W, port 830.3 is connected to the augmenter's LAN port 720L, and port 830.3 is connected to the WAN interface of router 320. The remaining connections can be as in FIG. 7 or 3 or as in other embodiments. The client-bound traffic flows from modem 704 through port 830.1, 830.2, 720W, 720L, 830.3, 830.4, in that order, to router 320. The internet-bound traffic flows in the reverse direction.

Switch 820 periodically sends packets on port 830.2 to make sure that the augmenter will pass them on to port 830.3. If switch 820 does not receive such packets on port 830.3, the switch connects its port 830.1 to port 830.4, so the augmenter is bypassed.

The invention is not limited to the embodiments described above. For example, in FIG. 2, processor 120 is shown separately from storage 124, but processors typically incorporate their own storage. Some or all of software 134.1 and 134.2 (FIG. 5C) may reside in the processor's storage. The invention is not limited to the Internet, HTML, or DOM. For example, some embodiments are restricted to a smaller network than the Internet. Some embodiments are available for non-HTML documents, e.g. for XML documents. In still other embodiments, the network is the Internet, but augmenter 204 augments not any HTML document but only documents satisfying some criteria, e.g. only the HTML and XML documents from selected servers 210 or from selected URLs. The invention is not limited to a mouse or any other input device. For example, a touchscreen display, a microphone (for voice input), or other input devices can be used to allow the user to point to an element of HTML document 160 in window 174 or to other displayed elements.

Some embodiments do not use windows. For example, a browser or other program 140 may be executed by a non-windowing computer system. Non-limiting examples of such systems include some mobile phones and some low-processing-power computers (e.g. tablet computers). The browser may allocate overlays 190 on a display device of the computer system. Other embodiments and variations are within the scope of the invention, as defined by the appended claims.

For example, some embodiments provide a method, such as can be performed by augmenter 204 or another entity, for processing network traffic in a computer network, the network traffic comprising documents (e.g. HTML documents 160 or other types of documents) flowing to one or more destinations (e.g. clients 110) each of which is a computer system comprising a display device (e.g. one or more computer monitors, mobile-phone displays, or other types of display devices). The computer system comprises a user interface operable to render documents in association with the display device.

Each destination is operable to provide, to the computer network, first requests (e.g. 136) for documents, and each destination is operable to receive documents in response to the first requests and to render the documents in association with the display device.

The network comprises a first computer system (e.g. server 150, which can be a single computer or can be a distributed server running on a number of networked computers). The first computer system is operable to provide access to first code (e.g. 178) executable by each destination, the destination being operable to allocate one or more areas (e.g. overlays 190) associated with the display device and to execute the first code in association with the one or more areas, the one or more areas being used to render human-perceptible content output by the first code.

The method comprises:

(1) receiving a plurality of documents responsive to the first requests;

(2) for each document in said plurality, augmenting the document with an augment to obtain an augmented document, and providing the augmented document to at least one destination of the document, the augment being associated with one or more references to all or part or parts of the first code (e.g. 178.0, or as in Listing 2 lines 5-7). The augment is for causing the destination to determine if at least part of the first code is to be obtained from the first computer system by using at least one of the one or more references and is to be executed, by at least the destination (e.g. by a client 110 and, possibly, other systems such as server 150), in association with one or more areas. Thus, the “at least part of the first code” may correspond to the code 178.0 which is referenced, via a URL, in augment 220. The at least part of the first code may also correspond to code 178.1 fetched by code 178.0 in response to user commands.

Execution of the at least part of the first code by at least the destination comprises maintaining, in computer storage (e.g. at client 110, and/or server 150, and/or another computer), state data indicative of a current state of the first code being executed, the state data to be used to provide continued execution, of the first code being executed, in association with the one or more areas when documents are received in response to multiple first requests.

In some embodiments, the user interface is operable to use windows in association with the display device. The term “window” as used herein includes a visual structure, such as a tab, that can be used to display a document's visual content or to play audio content incorporated into the document directly or by reference.

Further, each first request is associated with a window. For each destination's first request and each document received by the destination in response to the first request, the destination is operable to associate the document with one or more windows including the window associated with the first request. For example, if a user requested a document to be displayed in a window 174, but the document included instructions to the browser to create a pop-up window, then the document can be associated with both the window 174 associated with the request and the pop-up window. The destination is operable to render the document in association with the associated one or more windows. The one or more windows provide user interface to the document.

Further, in each destination, the one or more areas (e.g. overlays 190) are allocated in one or more windows. In operation (2), for each document in said plurality, for at least one destination of the document, the augment in the document is for causing the destination to determine if the at least part of the first code is to be executed, by the destination, in association with one or more areas in one or more windows associated with the document.

Further, the state data is to be used to provide continued execution, of the first code being executed, in association with:

the one or more areas in at least one window when the window is consecutively associated with documents received in response to respective consecutive first requests (e.g. when the user consecutively requests the same or different documents HTML 160 to be loaded into the same window 174); and/or

the one or more areas in different windows when the windows are associated with documents received in response to respective first requests.

In some embodiments, the first code comprises one or more first computer programs (e.g. a word processor, an email program, a chat program, etc.), and the state data identify each first computer program being executed and identify the state of each first computer program being executed.

In some embodiments, the state data are maintained on a per-user basis, wherein for each user for whom multiple windows are simultaneously associated with (the same or different) augmented documents, each window comprises said one or more areas through which user interface is provided to the first code.

In some embodiments, for each window of at least some of the windows in which the one or more areas are allocated, the documents rendered in the window are operable to be displayed adjacent to the one or more areas (in areas 194 for example).

In some embodiments, each document is augmented with an identical augment. For example, the augments 220 can be identical for each document.

In some embodiments, the augmenting of each document is performed by a computer system (e.g. augmenter 204) distinct from any destination of the document (e.g. distinct from clients 110) and distinct from the document's source computer system (e.g. server 210 or 150) which transmits the document over the computer network in response to the associated first request.

In some embodiments, all network traffic between the one or more destinations and the computer network flows through said distinct computer system (see FIG. 3 for example).

In some embodiments, said plurality of documents (i.e. the documents 160 being augmented—augmentation does not have to be performed on all the documents flowing from the Internet to clients 110) comprises documents received from a plurality of computer systems (e.g. from multiple servers 210) on the computer network.

In some embodiments, each first request is associated with the document's location address (e.g. URL) in the computer network, and said plurality of documents comprises documents at different location addresses.

In some embodiments, said plurality of documents comprise HTML documents associated with different URLs (Uniform Resource Locators).

In some embodiments, at least part of the first code, when executed, sets up an event notification to cause at least part of the first code being executed to be notified of an event related to a user interaction with the document (e.g. mouse-down, etc.) whose augment caused the at least part of the first code to be launched.

Some embodiments provide a method for processing network traffic in a computer network, the network traffic comprising documents flowing to one or more destinations each of which is a computer system. The network comprises a first computer system which is operable to provide access to first code executable by each destination. The method comprises:

(1) receiving a plurality of documents responsive to the first requests;

(2) for each document in said plurality, augmenting the document with an augment to obtain an augmented document, and providing the augmented document to at least one destination of the document, the augment being associated with one or more references to all or part or parts of the first code, the augment being for causing the destination to determine if at least part of the first code is to be obtained from the first computer system by using at least one of the one or more references and is to be executed by at least the destination.

Execution of the at least part of the first code by at least the destination comprises one or more of:

(a) the first code being executed obtaining read and/or write access to a document representation (e.g. 170) of the document, the document representation being used by the destination to render the document and/or to execute code in the document if the document contains code;

(b) the first code being executed requesting that event notification(s) be set up to cause the destination to notify at least part of the first code of an event or events associated with the document.

In some embodiments, the event or events are associated with a user interacting with the document.

In some embodiments, each destination comprises user interface operable to use windows. Each document is associated with one or more windows and is rendered by the destination in association with one or more windows. The event or events are associated with a user interacting with a window associated with the document.

Some embodiments provide a method for processing network traffic in a computer network, the network traffic flowing to one or more destinations, each destination being a computer system, each destination comprising a user interface operable to use windows to provide human-perceptible content in association with windows. Each destination is operable to execute a corresponding first processing entity (e.g. browser 140 with or without interpreter 182) which provides first programming interface (e.g. API 186) between objects associated with a single window but not between objects associated with any set of different windows at the destination. For example, the API 186 may be restricted for security reasons.

Each destination's first processing entity is operable to receive, from the network, first documents each of which comprises human-perceptible content, each first document being associated with a source address (e.g. document's URL) comprising a resource locator (e.g. URL) of a resource on the network, the first processing entity being operable to associate each first document and its source address with one or more windows at the destination, and to provide the human-perceptible content of the first document at the destination in association with the one or more windows associated with the first document.

The network comprises a first computer system (e.g. server 150) which is operable to provide access to first code executable by each first processing entity. The method comprises:

(1) receiving documents associated with a plurality of source addresses and flowing to the one or more first processing entities at the one or more destinations;

(2) for each document in said plurality, augmenting the document with an augment to obtain an augmented document, and providing the augmented document to at least one destination of the document, the augment being associated with one or more references to all or part or parts of the first code, the augment being for causing the destination to determine if at least part of the first code is to be obtained from the first computer system by using at least one of the one or more references and is to be executed, by at least the destination, in association with one or more windows associated with the document.

Operation (2) augments documents associated with different source addresses, thus providing the first programming interface between (i) at least part of the first code and (ii) objects associated with different source addresses.

Some embodiments provide a manufacture comprising computer-readable instructions operable to perform any of the methods described above when executed by one or more computer processors (e.g. processors 700 of FIG. 7). A manufacture example is augmenter 204. Another example of the manufacture is the augmenter's storage 702 (this can be semiconductor storage, magnetic storage, optical storage, or other kinds of storage).

In particular, the manufacture may include the one or more computer processors, an input (e.g. a network port or plural network ports, such as 720W; these can be input ports or input/output ports) for receiving, over the computer network, the documents to be augmented, and a computer storage (e.g. 702) storing said instructions. The instructions are operable to augment the documents when the instructions are executed by the one or more computer processors.

In some embodiments, the manufacture comprises an output (e.g. one or more network ports such as 720L; these can be output ports or input/output ports) for network transmission of the augmented documents to the one or more destinations.

Any combination of features of different embodiments described above can be provided in a single embodiment unless such features are mutually incompatible. Any feature of any embodiment described above can be provided in a single embodiment by itself to the exclusion of any other features, or in any combination with any other features, unless the resulting single embodiment would be inoperable. The invention is not limited to any embodiments described herein except as defined by the appended claims.

### REFERENCES (INCORPORATED HEREIN BY REFERENCE)

R1: David Flanagan, “JavaScript: The Definitive Guide”, O'Reilly Media, Inc. 2006.

R2: A. Kingsley-Hughes et al., “VBScript Programmer's Reference”, Second Edition, Wiley Publishing, Inc., 2004.

R3: James Gosling et al., “The Java Language Specification”, Second Edition, Sun Microsystems, Inc., 2000.

R4: Colin Moock, “ActionScript for Flash MX: The Definitive Guide”, Second Edition, O'Reilly & Associates, Inc., 2003.

R5: Document Object Model (DOM) Level 1 Specification (Second Edition) Version 1.0, W3C Working Draft 29 Sep. 2000.

R6: Document Object Model (DOM) Level 2 Core Specification Version 1.0, W3C Recommendation, 13 Nov. 2000.

R7: Document Object Model (DOM) Level 3 Core Specification Version 1.0, W3C Recommendation, 7 Apr. 2004.

R8: “What are local shared objects?”, Adobe Systems Incorporated, Jul. 14, 2009, at http://www.adobe.com/products/flashplayer/articles/lso/.

R9: “Local Connections”, Adobe Systems Incorporated, 2007, at http://learn.adobe.com/wiki/display/Flex/Local+Connections.

1. A method for processing network traffic in a computer network, the network traffic comprising documents flowing to one or more destinations each of which is a computer system comprising a display device, the computer system comprising a user interface operable to render documents in association with the display device;
wherein each destination is operable to provide, to the computer network, first requests for documents, and each destination is operable to receive documents in response to the first requests and to render the documents in association with the display device;
wherein the network comprises a first computer system which is operable to provide access to first code executable by each destination, the destination being operable to allocate one or more areas associated with the display device and to execute the first code in association with the one or more areas, the one or more areas being used to render human-perceptible content output by the first code;
the method comprising:
(1) receiving a plurality of documents responsive to the first requests;
(2) for each document in said plurality, augmenting the document with an augment to obtain an augmented document, and providing the augmented document to at least one destination of the document, the augment being associated with one or more references to all or part or parts of the first code, the augment being for causing the destination to determine if at least part of the first code is to be obtained from the first computer system by using at least one of the one or more references and is to be executed, by at least the destination, in association with one or more areas;
wherein execution of the at least part of the first code by at least the destination comprises maintaining, in computer storage, state data indicative of a current state of the first code being executed, the state data to be used to provide continued execution, of the first code being executed, in association with the one or more areas when documents are received in response to multiple first requests.

2. The method of claim 1 wherein:
the user interface is operable to use windows in association with the display device;
each first request is associated with a window;
for each destination's first request and each document received by the destination in response to the first request, the destination is operable to associate the document with one or more windows including the window associated with the first request, and to render the document in association with the associated one or more windows which provide user interface to the document;
in each destination, the one or more areas are allocated in one or more windows;
in operation (2), for each document in said plurality, for at least one destination of the document, the augment in the document is for causing the destination to determine if the at least part of the first code is to be executed, by the destination, in association with one or more areas in one or more windows associated with the document;
wherein the state data is to be used to provide continued execution, of the first code being executed, in association with:
the one or more areas in at least one window when the window is consecutively associated with documents received in response to respective consecutive first requests; and/or
the one or more areas in different windows when the windows are associated with documents received in response to respective first requests.

3. The method of claim 1 wherein the first code comprises one or more first computer programs, and the state data identify each first computer program being executed and identify the state of each first computer program being executed.

4. The method of claim 2 wherein the state data are maintained on a per-user basis, wherein for each user for whom multiple windows are simultaneously associated with augmented documents, each window comprises said one or more areas through which user interface is provided to the first code.

5. The method of claim 2 wherein for each window of at least some of the windows in which the one or more areas are allocated, the documents rendered in the window are operable to be displayed adjacent to the one or more areas.

6. The method of claim 1 wherein each document is augmented with an identical augment.

7. The method of claim 1 wherein the augmenting of each document is performed by a computer system distinct from any destination of the document and distinct from the document's source computer system which transmits the document over the computer network in response to the associated first request.

8. The method of claim 7 wherein all network traffic between the one or more destinations and the computer network flows through said distinct computer system.

9. The method of claim 1 wherein said plurality of documents comprises documents received from a plurality of computer systems on the computer network.

10. The method of claim 9 wherein each first request is associated with the document's location address in the computer network, and said plurality of documents comprises documents at different location addresses.

11. The method of claim 9 wherein said plurality of documents comprise HTML documents associated with different URLs (Uniform Resource Locators).

12. The method of claim 1 wherein at least part of the first code, when executed, sets up an event notification to cause at least part of the first code being executed to be notified of an event related to a user interaction with the document whose augment caused the at least part of the first code to be launched.

13. The method of claim 1 further comprising at least one destination receiving the document provided to the destination in operation (2), the destination obtaining at least part of the first code from the first computer system and the destination executing the at least part of the first code.

14-16. (canceled)

17. A method for processing network traffic in a computer network, the network traffic comprising documents flowing to one or more destinations each of which is a computer system;
wherein the network comprises a first computer system which is operable to provide access to first code executable by each destination;
the method comprising:
(1) receiving a plurality of documents responsive to the first requests;
(2) for each document in said plurality, augmenting the document with an augment to obtain an augmented document, and providing the augmented document to at least one destination of the document, the augment being associated with one or more references to all or part or parts of the first code, the augment being for causing the destination to determine if at least part of the first code is to be obtained from the first computer system by using at least one of the one or more references and is to be executed by at least the destination;
wherein execution of the at least part of the first code by at least the destination comprises one or more of:
(a) the first code being executed obtaining read and/or write access to a document representation of the document, the document representation being used by the destination to render the document and/or to execute code in the document if the document contains code;
(b) the first code being executed requesting that event notification(s) be set up to cause the destination to notify at least part of the first code of an event or events associated with the document.

18. The method of claim 17 wherein the event or events are associated with a user interacting with the document.

19-28. (canceled)

29. A method for processing network traffic in a computer network, the network traffic flowing to one or more destinations, each destination being a computer system, each destination comprising a user interface operable to use windows to provide human-perceptible content in association with windows;
wherein each destination is operable to execute a corresponding first processing entity which provides first programming interface between objects associated with a single window but not between objects associated with any set of different windows at the destination;
wherein each destination's first processing entity is operable to receive, from the network, documents each of which comprises human-perceptible content, each document being associated with a source address comprising a resource locator of a resource on the network, the first processing entity being operable to associate each document and its source address with one or more windows at the destination, and to provide the human-perceptible content of the document at the destination in association with the one or more windows associated with the document;
wherein the network comprises a first computer system which is operable to provide access to first code executable by each first processing entity;
the method comprising:
(1) receiving documents associated with a plurality of source addresses and flowing to the one or more first processing entities at the one or more destinations;
(2) for each document in said plurality, augmenting the document with an augment to obtain an augmented document, and providing the augmented document to at least one destination of the document, the augment being associated with one or more references to all or part or parts of the first code, the augment being for causing the destination to determine if at least part of the first code is to be obtained from the first computer system by using at least one of the one or more references and is to be executed, by at least the destination, in association with one or more windows associated with the document;
wherein operation (2) augments documents associated with different source addresses, thus providing the first programming interface between (i) at least part of the first code and (ii) objects associated with different source addresses.

30. The method of claim 29 wherein each document is augmented with an identical augment.

31. The method of claim 29 wherein the augmenting of each document is performed by a computer system distinct from any destination of the document and distinct from the document's source computer system which transmits the document over the computer network in response to the associated first request.

32. The method of claim 31 wherein all network traffic between the one or more destinations and the computer network flows through said distinct computer system.

33. The method of claim 29 wherein said plurality of documents comprise HTML documents, and the source addresses are URLs (Uniform Resource Locators).

34-36. (canceled)
